(19) United States
(12) Patent Application Publication
(10) Pub. No.: US 2016/0164214 A1
(43) Pub. Date: Jun. 9, 2016

(54) CONNECTOR COVER AND METHOD FOR MANUFACTURING THE SAME

(71) Applicant: SUMITOMO WIRING SYSTEMS, LTD., Yokkaichi, Mie (JP)

(72) Inventor: Hitoshi Itou, Yokkaichi, Mie (JP)

(73) Assignee: SUMITOMO WIRING SYSTEMS, LTD., Yokkaichi, Mie (JP)

(21) Appl. No.: 14/783,330

(22) PCT Filed: Apr. 7, 2014
(86) PCT No.: PCT/JP2014/060047

§ 371 Date: Nov. 17, 2015

(30) Foreign Application Priority Data
Apr. 11, 2013 (JP) 2013-083200

(51) Int. Cl. H01R 13/50; H01R 43/18

(52) U.S. Cl. CPC H01R 13/50; H01R 43/18

(57) ABSTRACT

In order to provide a connector cover amenable to precise control of the outer diameter dimensions and suppression of shininess on the outer surface thereof, and a method for manufacturing the same, a shaping mold (21) in which a through-hole (22) having a predetermined inner diameter dimension is formed along an immersion direction is immersed in a solution of thermoplastic resin. The shaping mold (21) is pulled up from the solution, and the resin adhering to an inner surface portion of the through-hole (22) of the shaping mold (21) is gelled, so that a precursor (110) is shaped. The precursor (110) is released from the shaping mold (21), and an unnecessary portion (111) of the precursor (110) is cut off. The thus manufactured connector cover (10) that is attachable to a connector into which a terminal connected to ends of an electrical wire bundle in a wire harness is inserted and fastened has an outer diameter dimension in conformity with the inner diameter dimension of the through-hole (22) and has an outer surface that is a matte face or a grainy satin face.

### CROSS-REFERENCE TO RELATED APPLICATIONS

This application is the U.S. national stage of PCT/JP2014/060047 filed Apr. 7, 2014, which claims priority of Japanese Patent Application 2013-083200 filed Apr. 11, 2013.

### FIELD OF THE INVENTION

The present invention relates to a connector cover for protecting a connector and the like of a wire harness, and a method for manufacturing the same.

### BACKGROUND OF THE INVENTION

Conventionally, as a method for manufacturing covers and the like used to protect connectors and terminals of wire harnesses, a method is known that uses a male shaping mold (see Patent Document 1, for example).

Specifically, a pre-heated male shaping mold is immersed in a solution of thermoplastic resin to which a foaming agent has been added, after which the male shaping mold is pulled up in a state where the solution has uniformly adhered to the surface of the male shaping mold, and is heated, so that the adhering solution is gelled and is foamed. Subsequently, the male shaping mold is cooled down, so that the solution is released from the mold to form a molded product that is a precursor. Then, an unnecessary portion is cut off from the molded product that has been released from the mold, so that a connector cover having a desired shape is obtained.

According to this sort of conventional manufacturing method, a desired molded product is shaped by causing a solution of thermoplastic resin to adhere to the surface, that is, the outer circumferential face of a mold. Thus, there is a problem in that, although the face on the inner side of the obtained connector cover, that is, the inner surface in contact with the mold is shaped exactly in conformity with the dimensions of the mold, the face on the outer side of the cover, that is, the outer surface has dimensions that vary in accordance with the amount of solution that adheres to the mold.

That is to say, the connector cover obtained according to the method described in JP S60-105118A is problematic in that, although the dimensions on the inner surface side, that is, the inner diameter dimensions are in conformity with the dimensions of the mold, the dimensions on the outer surface side, that is, the outer diameter dimensions depend on the amount of solution that adheres to the mold, and, thus, it is difficult to obtain constant dimensions due to variation in the wall thickness and the like.

Especially in the case of wire harnesses used for electrical connection in vehicles and the like, in the future, it will be more important to precisely control the outer diameter dimensions of a connector cover when it is arranged in a narrow space or the like.

Furthermore, according to the method described in JP S60-105118A, if PVC (polyvinyl chloride) is used as the solution of thermoplastic resin, the outer surface of the obtained connector cover becomes glossy. If such a connector cover is used at a visible portion of vehicles, for example, the glossy face becomes conspicuous as “shininess”, and, thus, use thereof in vehicles is not preferable.

### SUMMARY OF THE INVENTION

The present invention was made in order to solve these problems, and it is an object thereof to provide a connector cover amenable to precise control of the outer diameter dimensions and suppression of shininess on its outer surface, and a method for manufacturing the same.

The present invention is directed to a connector cover that is attachable to a connector. A terminal connected to respective ends of an electrical wire bundle in a wire harness is inserted and fastened into the connector. The connector cover is formed by: immersing a mold in a solution of thermoplastic resin, the mold having a through-hole, the through-hole having a predetermined inner diameter formed along an immersion direction, and pulling up the mold; shaping a precursor by gelling the resin adhering to the mold; releasing the precursor from the mold; and cutting off an unnecessary portion of the precursor.

According to the thus configured connector cover of the present invention, the outer diameter dimensions thereof can be in conformity with predetermined inner diameter dimensions of the through-hole of the mold, and the outer face thereof can be a grainy face or a matte face.

The connector cover according to the present invention may have a large-diameter connector covering portion that can cover the connector, a small-diameter electrical wire covering portion that can cover the electrical wire bundle, and a coupling portion that continuously couples the electrical wire covering portion and the connector covering portion into one piece.

According to the thus configured connector cover of the present invention, a desired shape can be obtained in accordance with the shape of the through-hole, and this connector cover is preferable as a connector cover for protecting a connector and the like of a wire harness.

Furthermore, the present invention is directed to a method for manufacturing the connector cover, including: pre-heating the mold; immersing the mold in the solution of thermoplastic resin, and pulling up the mold with the resin adhering to an outer face of the mold and an inner face of the through-hole; releasing the precursor shaped by gelling the adhering resin from the mold; and cutting off an unnecessary portion of the precursor.

According to the thus configured method for manufacturing a connector cover of the present invention, the outer diameter dimensions of the connector cover can be in conformity with predetermined inner diameter dimensions of the through-hole of the mold, and the outer face of the connector cover can be a grainy face or a matte face.

According to the present invention, it is possible to provide a connector cover amenable to precise control of the outer diameter dimensions and suppression of shininess on its outer face, and a method for manufacturing the same.

### BRIEF DESCRIPTION OF THE DRAWINGS

FIG. 1 is a cross-sectional view showing a connector cover according to an embodiment of the present invention.

FIG. 2A is a perspective view of a shaping mold for use in the manufacture of the connector cover according to the embodiment of the present invention.

FIG. 2B is a cross-sectional view of the shaping mold for use in the manufacture of the connector cover according to the embodiment of the present invention.

FIG. 2C is a cross-sectional view of the shaping mold and a precursor for use in the manufacture of the connector cover according to the embodiment of the present invention.

FIG. 2D is a cross-sectional view of the precursor for use in the manufacture of the connector cover according to the embodiment of the present invention.

FIG. 3A is a cross-sectional view showing a connector cover according to another embodiment of the present invention.

FIG. 3B is a cross-sectional view showing a connector cover according to this other embodiment of the present invention.

FIG. 4A is a perspective view of a shaping mold for use in the manufacture of the connector covers according to this other embodiment.

FIG. 4B is a cross-sectional view of the shaping mold for use in the manufacture of the connector covers according to this other embodiment.

FIG. 4C is a cross-sectional view of the shaping mold and a precursor for use in the manufacture of the connector covers according to this other embodiment.

FIG. 4D is a perspective view of the shaping mold and the precursor for use in the manufacture of the connector covers according to this other embodiment.

FIG. 4E is a cross-sectional view of the precursor for use in the manufacture of the connector covers according to this other embodiment.

### DETAILED DESCRIPTION OF THE PREFERRED EMBODIMENTS

Hereinafter, embodiments of the present invention will be described with reference to the drawings.

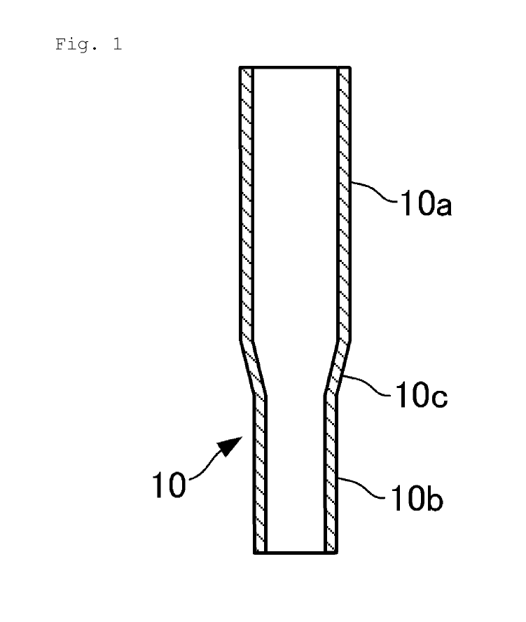

FIG. 1 shows a connector cover according to this embodiment.

As shown in FIG. 1, a connector cover 10 has a large-diameter connector covering portion 10a that can cover a connector into which a terminal or terminals connected to ends of an electrical wire bundle in a wire harness (not shown) are inserted and fastened, a small-diameter electrical wire covering portion 10b that can cover the electrical wire bundle, and a coupling portion 10c that continuously couples the connector covering portion 10a and the electrical wire covering portion 10b into one piece.

The connector cover 10 is manufactured using a shaping mold 21, which will be described later, so that the outer diameter dimensions thereof are in conformity with predetermined inner diameter dimensions of a through-hole 22 of the mold 21, and the outer face thereof is a grainy face or a matte face.

This configuration makes it easy to precisely control the outer diameter dimensions of the connector cover 10, and, thus, the connector cover 10 can be preferably used, for example, in the case where a wire harness used for electrical connection in a vehicle is arranged in a narrow space.

Furthermore, when the connector cover 10 is made of, for example, PVC, the outer circumferential face can be prevented from being glossy. Thus, also in the case of use especially at a visible portion of a vehicle, “shininess” can be suppressed.

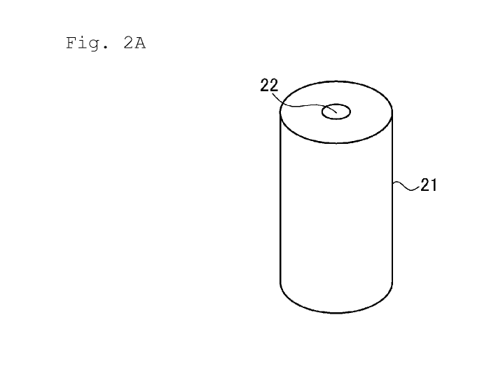

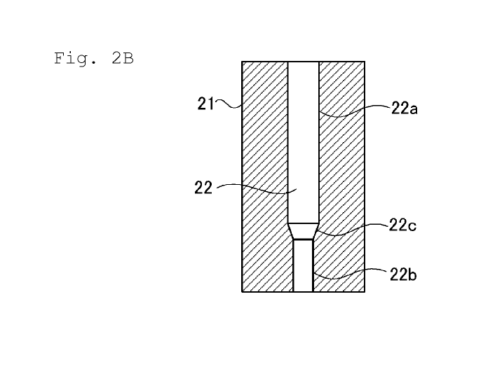

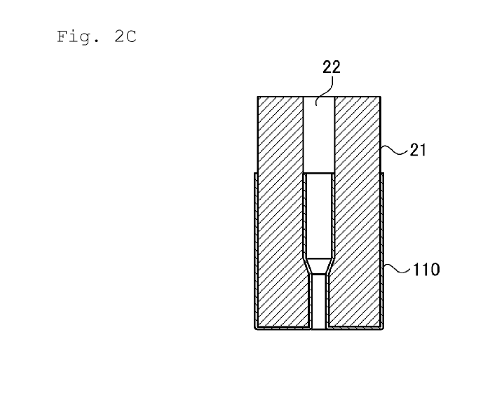

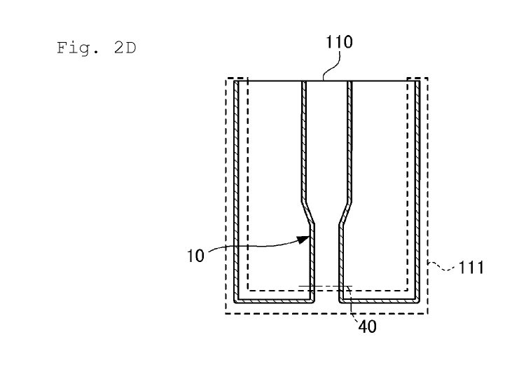

FIGS. 2A to 2D illustrate a method for manufacturing the connector cover 10 shown in FIG. 1. FIG. 2A is a perspective view of the shaping mold 21 for use in the manufacture of the connector cover 10 according to this embodiment, FIG. 2B is a cross-sectional view of the shaping mold 21, FIG. 2C is a cross-sectional view of the shaping mold 21 and a precursor 110, and FIG. 2D is a cross-sectional view of the precursor 110.

As shown in FIGS. 2A and 2B, first, the female shaping mold 21 is prepared. The through-hole 22 is formed in advance along the immersion direction at the time of dipping substantially at the center of the shaping mold 21.

The through-hole 22 has predetermined inner diameter dimensions in conformity with the outer diameter dimensions of the connector cover 10 that is to be manufactured. That is to say, in this embodiment, the through-hole 22 is provided with a through-hole portion 22a having inner diameter dimensions in conformity with the outer diameter dimensions of the connector covering portion 10a, a through-hole portion 22b having inner diameter dimensions in conformity with the outer diameter dimensions of the electrical wire covering portion 10b, and a through-hole portion 22c having inner diameter dimensions in conformity with the outer diameter dimensions of the coupling portion 10c.

The inner face of the through-hole 22 is, for example, subjected to matte treatment or made grainy.

This shaping mold 21 is pre-heated at a predetermined temperature, and the pre-heated shaping mold 21 is dipped from the bottom into a solution of, for example, PVC, which is a thermoplastic resin, in the opening direction of the through-hole 22, that is, in the immersion direction, to a predetermined depth.

Accordingly, resin for forming the precursor 110 of the connector cover 10 adheres uniformly with a predetermined thickness to the portion around the shaping mold 21 pulled up from the solution, that is, the outer surface portion of the mold 21 and the inner face of the through-hole 22, and the mold 21 is heated so that the adhering resin is gelled, and is then cooled down (see FIG. 2C).

In this manner, the shaped precursor 110 is released from the shaping mold 21 (see FIG. 2D). Subsequently, an unnecessary portion 111 of the precursor 110 indicated by the broken line portion in FIG. 2D is cut off along a cut-off portion 40, so that the connector cover 10 shown in FIG. 1 is finally manufactured.

The outer diameter dimensions of the connector cover 10 according to this embodiment are adjusted in accordance with the inner diameter dimensions of the through-hole 22 of the shaping mold 21. That is to say, the outer diameter dimensions of the connector cover 10 manufactured by the above-described method can be in conformity with predetermined inner diameter dimensions of the through-hole 22 of the shaping mold 21, and, thus, the outer diameter dimensions of the connector cover 10 can be precisely controlled.

Accordingly, even in the case where the wall thickness partially varies due to the own weight of the resin or the like, the outer diameter dimensions of the manufactured connector cover 10 can be always kept constant regardless of the manufacture conditions.

Accordingly, the connector cover 10 is particularly preferable as a cover for protecting a connector and the like in the case where a wire harness used for electrical connection in a vehicle is arranged in a narrow space or the like.

Furthermore, during the manufacture of the connector cover 10, the resin is in contact with the inner face of the through-hole 22 of the shaping mold 21, and, thus, even in the case where PVC is used as the resin, the outer face of the connector cover 10 can be made a grainy face or a matte face, and “shininess” can be prevented.

That is to say, since the connector cover 10 is formed by causing resin to adhere to the inner face of the through-hole 22 of the shaping mold 21, if the inner face of the through-hole 22 is subjected to matte treatment or made grainy, the connector cover 10 can be preferably used also at a visible portion of a vehicle, for example, without using a special material for the resin or the like or performing post-treatment.

Note that the connector cover that can be manufactured is not limited to the connector cover 10 described in the foregoing embodiment, and various connector covers can be manufactured in accordance with the number of through-holes 22 of the prepared shaping mold 21, the inner diameter dimensions of each through-hole 22, the shape of each through-hole 22, or the like.

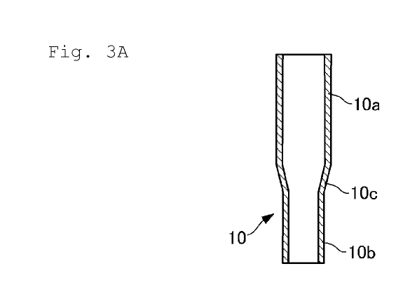

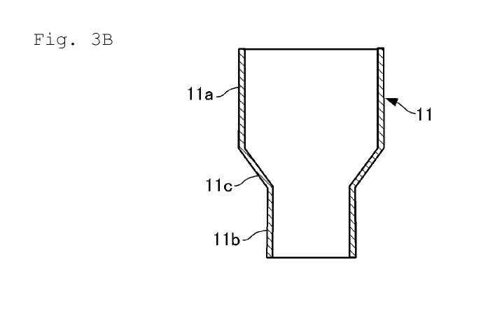

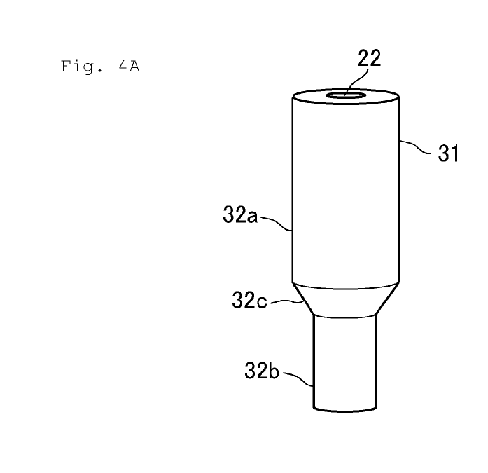

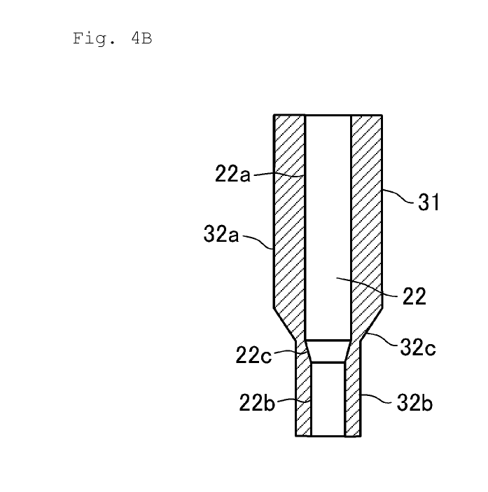

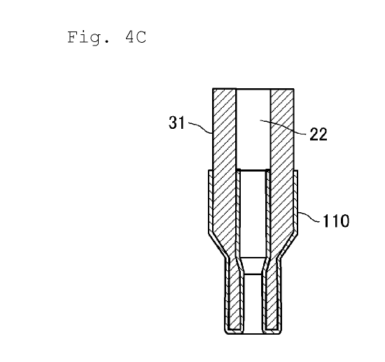

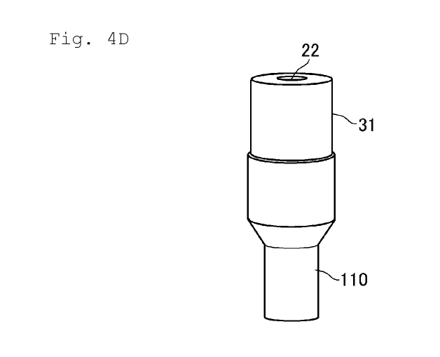

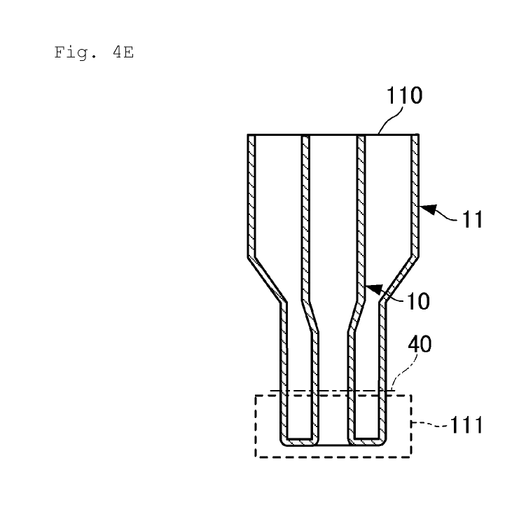

FIGS. 3A, 3B and 4A to 4E show connector covers and a method for manufacturing the same according to another embodiment.

Hereinafter, the case in which two types of connector covers having different sizes are simultaneously manufactured will be described as an example. Note that, in FIGS. 3A, 3B, and 4A to 4E, the same constituent elements as those in FIGS. 1 and 2A to 2D are denoted by the same reference numerals and a detailed description thereof has been omitted.

Incidentally, FIG. 3A is a cross-sectional view of the connector cover 10 according to another embodiment, which is the same as the connector cover 10 according to the foregoing embodiment (see FIG. 1). FIG. 3B is a cross-sectional view of a connector cover 11 according to this other embodiment. FIG. 4A is a perspective view of a shaping mold 31 for use in the manufacture of the connector covers 10 and 11 according to this other embodiment, FIG. 4B is a cross-sectional view of the shaping mold 31, FIG. 4C is a cross-sectional view of the shaping mold 31 and the precursor 110, FIG. 4D is a perspective view of the shaping mold 31 and the precursor 110, and FIG. 4E is a cross-sectional view of the precursor 110.

That is to say, in this other embodiment, the shaping mold 31 is a mold in which the outer face of the female shaping mold 21 shown in FIGS. 2A to 2D is used as a male mold for manufacturing the connector cover 11 having a size different from that of the connector cover 10. With use of the shaping mold 31, the connector covers 10 and 11 can be simultaneously manufactured.

More specifically, as shown in FIGS. 4A and 4B, the through-hole 22 is formed in advance along the immersion direction at the time of dipping substantially at the center of the shaping mold 31. Furthermore, the outer face of the shaping mold 31 is provided with an outer circumferential face portion 32a having an outer diameter dimensions in conformity with the inner diameter dimensions of a connector covering portion 11a of the connector cover 11 that is to be manufactured, an outer circumferential face portion 32b having outer diameter dimensions in conformity with the inner diameter dimensions of an electrical wire covering portion 11b, and an outer circumferential face portion 32c having outer diameter dimensions in conformity with the inner diameter dimensions of a coupling portion 11c.

This shaping mold 31 is pre-heated at a predetermined temperature, and the pre-heated shaping mold 31 is dipped from the bottom into a solution of, for example, PVC, which is a thermoplastic resin, in the opening direction of the through-hole 22, that is, in the immersion direction, to a predetermined depth.

Accordingly, resin for forming the precursor 110 of the connector covers 10 and 11 adhering uniformly with a predetermined thickness to the outer face of the shaping mold 31 pulled up from the solution and the inner face of the through-hole 22 is gelled, and is then cooled down (see FIGS. 4C and 4D).

In this manner, the shaped precursor 110 is released from the shaping mold 31 (see FIG. 4E). Subsequently, the unnecessary portion 111 of the precursor 110 indicated by the broken line portion in FIG. 4E is cut off along the cut-off portion 40, so that the connector cover 10 shown in FIG. 3A and the connector cover 11 shown in FIG. 3B are finally simultaneously manufactured.

According to this other embodiment, in a wire harness used for electrical connection in a vehicle, the connector cover 10 that is preferable as a cover for protecting a connector and the like and the connector cover 11 having a size larger than that of the connector cover 10 can be simultaneously obtained.

It will be appreciated that the embodiment and other embodiment described above are not limited to the manufacture of connector covers.

As described above, the connector cover and the method for manufacturing the same according to the present invention have effects that the outer diameter dimensions can be precisely controlled and shininess on the outer face can be suppressed, and, thus, they are generally useful as a connector cover for protecting a connector and the like of a wire harness, and a method for manufacturing the same.

1. A connector cover configured to be attachable to a connector into which a terminal, connected to respective ends of an electrical wire bundle in a wire harness, is inserted and fastened, the connector cover prepared by the process comprising the steps of:
immersing a mold in a solution of thermoplastic resin, the mold having a through-hole, the through-hole having a predetermined inner diameter formed along an immersion direction and pulling up the mold;
shaping a precursor by gelling the resin adhering to the mold;
releasing the precursor from the mold; and
cutting off an unnecessary portion of the precursor.

2. The connector cover according to claim 1, wherein the through-hole of the mold is dimensioned to form a large-diameter connector covering portion that can cover the connector, a small-diameter electrical wire covering portion that can cover the electrical wire bundle, and a coupling portion that continuously couples the electrical wire covering portion and the connector covering portion into one piece.

3. A method for manufacturing the connector cover according to claim 1, further including the steps of:
pre-heating the mold;
pulling up the mold with the resin adhering to an outer face of the mold and an inner face of the through-hole;
releasing the precursor shaped by gelling the adhering resin from the mold; and
cutting off an unnecessary portion of the precursor.

4. A method for manufacturing the connector cover according to claim 2, further including the steps of:
pre-heating the mold;
pulling up the mold with the resin adhering to an outer face of the mold and an inner face of the through-hole;
releasing the precursor shaped by gelling the adhering resin from the mold; and
cutting off an unnecessary portion of the precursor.

5. A method for manufacturing the connector cover configured to be attachable to a connector into which a terminal, connected to respective ends of an electrical wire bundle in a wire harness, is inserted and fastened, the method comprising the steps of:
immersing a mold in a solution of thermoplastic resin, the mold having a through-hole, the through-hole having a predetermined inner diameter formed along an immersion direction, and pulling up the mold;
shaping a precursor by gelling the resin adhering to the mold;
releasing the precursor from the mold; and
cutting off an unnecessary portion of the precursor.

6. The method according to claim 5, wherein the through-hole of the mold is dimensioned to form a large-diameter connector covering portion that can cover the connector, a small-diameter electrical wire covering portion that can cover the electrical wire bundle, and a coupling portion that continuously couples the electrical wire covering portion and the connector covering portion into one piece.

7. The method according to claim 5, further including the steps of:
pre-heating the mold;
pulling up the mold with the resin adhering to an outer face of the mold and an inner face of the through-hole;
releasing the precursor shaped by gelling the adhering resin from the mold; and
cutting off an unnecessary portion of the precursor.
